(19) United States
(12) Patent Application Publication
(10) Pub. No.: US 2023/0205816 A1
(43) Pub. Date: Jun. 29, 2023

(54) INFORMATION PROCESSING DEVICE, CONTROL METHOD, AND RECORDING MEDIUM

(71) Applicant: NEC Corporation, Minato-ku, Tokyo (JP)

(72) Inventors: Yu Nabeto, Tokyo (JP); Katsumi Kikuchi, Tokyo (JP); Soma Shiraishi, Tokyo (JP); Haruna Watanabe, Tokyo (JP)

(73) Assignee: NEC Corporation, Minato-ku, Tokyo (JP)

(21) Appl. No.: 17/927,068

(22) PCT Filed: May 28, 2020
(86) PCT No.: PCT/JP2020/021146

§ 371 Date: Nov. 22, 2022

(51) Int. Cl. G06F 16/75

(52) U.S. Cl. CPC G06F 16/75

(57) ABSTRACT

An information processing device 1X mainly includes an inference means 15X, an input reception means 16X, and a digest candidate generation means 17X. The inference means 15X acquires an inference result for each inference engine to video material data by a plurality of inference engines which perform respective inferences concerning a degree of importance with respect to video data being input. The input reception means 16X receives an input indicating parameters concerning the inference result for each inference engine. The digest candidate generation means 17X generates a digest candidate which is a candidate of a digest of the video material data, based on the parameters and the inference result for each inference engine.

### TECHNICAL FIELD

The present disclosure relates to an information processing device, a control method, and a recording medium, which perform a process concerning a generation of a digest.

### BACKGROUND ART

There exists a technology which edits video data as a material and generates a digest. For example, Patent Document 1 discloses a method for producing the digest by confirming a highlight scene from a video stream of a sports event on the ground.

### PRECEDING TECHNICAL REFERENCES

### Patent Document

Patent Document 1: Japanese National Publication of International Patent Application No. 2019-522948

### SUMMARY

### Problem to be Solved by the Invention

Needs for an automatic editing of a video have been increased due to two demands: a time reduction of a video editing and a content expansion. In the automatic editing, it is possible to determine an important segment from multiple perspectives by using a plurality of inference engines, but it is difficult to appropriately combine inference results of the plurality of inference engines.

In view of the above problems, it is one object of the present disclosure to provide an information processing device, a control method, and a storage medium capable of preferably generating a digest candidate.

### Means for Solving the Problem

According to an example aspect of the present disclosure, there is provided an information processing device including: an inference means configured to acquire an inference result for each inference engine to video material data by a plurality of inference engines which perform respective inferences concerning a degree of importance with respect to video data being input; an input reception means configured to receive an input indicating parameters concerning the inference result for each inference engine; and a digest candidate generation means configured to generate a digest candidate which is a candidate of a digest of the video material data, based on the parameters and the inference result for each inference engine.

According to another example aspect of the present disclosure, there is provided a control method performed by a computer, the control method including: acquiring an inference result for each inference engine to video material data by a plurality of inference engines which perform respective inferences concerning a degree of importance with respect to video data being input; receiving an input indicating parameters concerning the inference result for each inference engine; and generating a digest candidate which is a candidate of a digest of the video material data, based on the parameters and the inference result for each inference engine.

According to a further example aspect of the present disclosure, there is provided a recording medium storing a program, the program causing a computer to perform a process including: acquiring an inference result for each inference engine to video material data by a plurality of inference engines which perform respective inferences concerning a degree of importance with respect to video data being input; receiving an input indicating parameters concerning the inference result for each inference engine; and generating a digest candidate which is a candidate of a digest of the video material data, based on the parameters and the inference result for each inference engine.

### Effect of the Invention

According to the present disclosure, it is possible to preferably generate a digest candidate by using a plurality of inference engines.

### BRIEF DESCRIPTION OF THE DRAWINGS

FIG. 1 illustrates a configuration of a digest generation support system in a first example embodiment.

FIG. 2 illustrates a hardware configuration of an information processing device.

FIG. 3 illustrates examples of functional blocks of the information processing device.

FIG. 4 illustrates a first display example of a digest generation support screen. FIG. 5 illustrates a second display example of the digest generation support screen.

FIG. 6 illustrates an example of a flowchart for explaining steps of a process executed by the information processing device in the first example embodiment.

FIG. 7 illustrates a third display example of the digest generation support screen.

FIG. 8 illustrates a configuration of a digest generation support system in a modification.

FIG. 9 is a functional block diagram illustrating an information processing device in a second example embodiment.

FIG. 10 illustrates an example of a flowchart for a process executed by the information processing device in the second example embodiment.

### EXAMPLE EMBODIMENTS

In the following, example embodiments of an information processing device, a control method, and a recording medium will be described with reference to the accompanying drawings.

### First Example Embodiment

(1) System Configuration

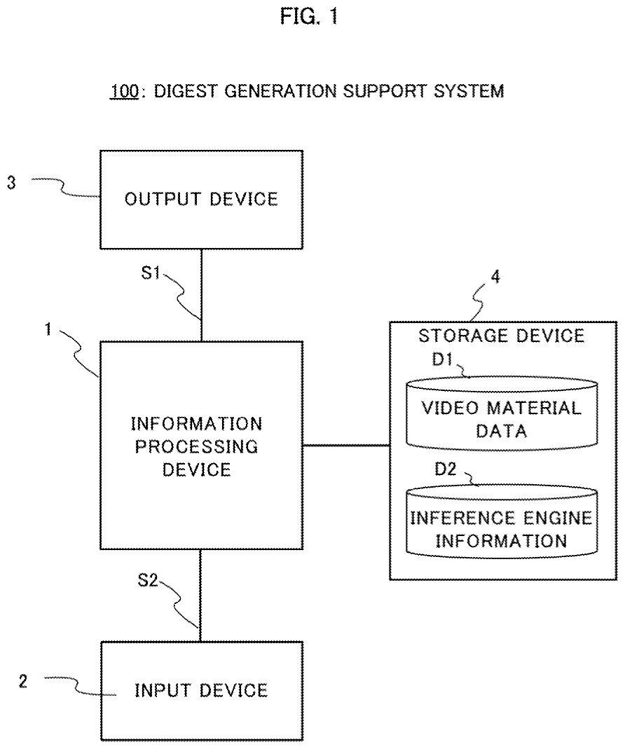

FIG. 1 illustrates a configuration of a digest generation support system 100 according to a first example embodiment. The digest generation support system 100 preferably supports a generation of video data (also referred to as a “digest candidate Cd”) as a candidate for a digest of video data to be a material. The digest generation support system 100 mainly includes an information processing device 1, an input device 2, an output device 3, and a storage device 4. Hereafter, the video data may include sound data.

The information processing device 1 performs data communications with the input device 2 and the output device 3 through a communication network or by a direct communication via a wireless or wired channel. The information processing device 1 generates the digest candidate Cd of video material data D1 by extracting video data of an important segment from the video material data D1 stored in the storage device 4.

The input device 2 is any user interface which accepts each user input, and corresponds to, for instance, a button, a keyboard, a mouse, a touch panel, a voice input device, or the like. The input device 2 supplies an input signal “S2” generated based on the user input to the information processing device 1. The output device 3 is, for instance, a display device such as a display or a projector, and a sound output device such as a speaker or the like, and performs a predetermined display or/and sound output (including a playback of the digest candidate Cd) based on an output signal “S1” supplied from the information processing device 1.

The storage device 4 is a memory that stores various kinds of information necessary for processes of the information processing device 1. The storage device 4 stores, for instance, the video material data D1 and inference engine information D2.

The video material data D1 are video data for which the digest candidate Cd is to be generated. In a case where a plurality of sets of video data are stored in the storage device 4 as the video material data D1, for instance, the digest candidate Cd is generated for the video data which the user designates by the input device 2.

The inference engine information D2 is information concerning a plurality of inference engines each which infers a score for video data being input. The above-described score is a score indicating a degree of importance for the input video data, and the above-described degree of importance is an index that serves as a reference for determining whether the input video data are an important segment or a non-important segment (that is, whether to be suitable as a segment of a digest). Moreover, each of the plurality of inference engines is a model that infers a score from a different point of interest with respect to the input video data.

Here, a plurality of inference engines include, for instance, an inference engine that infers the score based on images forming the input video data, and an inference engine that infers the score based on sound data included in the input video data. Moreover, the former inference engine may include an inference engine that infers the score based on the entire area of each of the images forming the input video data, and an inference engine that infers the score based on an area indicating a specific position (that is, a human face) in the images forming the input video data.

Incidentally, the inference engine, which infers the score based on the area indicating the specific portion in the images, may include, for instance, a front stage unit which extracts features related to the specific portion from the images, and a rear stage unit which infers the score related to the degree of importance from the extracted features. Another inference engine may similarly include a process unit which extracts the features related to a target point of interest, and a process unit which evaluates the score from the extracted features.

These inference engines are trained in advance, and the inference engine information D2 includes parameters for each of trained inference engines. Each learning model of the inference engines may be a learning model based on any machine learning such as a neural network or a support vector machine. For instance, in a case where each model of a first inference engine and a second inference engine described above is a neural network such as a convolutional neural network, the inference engine information D2 includes various parameters such as a layer structure, a neuron structure for each layer, the number of filters and filter sizes in each layer, respective weights of elements for each filter.

Note that the storage device 4 may be an external storage device such as a hard disk connected to or built in the information processing device 1, or may be a storage medium such as a flash memory or the like. Moreover, the storage device 4 may be a server device that performs data communications with the information processing device 1. Furthermore, the storage device 4 may include a plurality of devices. In this case, the storage device 4 may store the video material data D1 and the inference engine information D2 in a distributed manner.

The configuration of the digest generation support system 100 described above is an example, and various changes may be made to the configuration. For instance, the input device 2 and the output device 3 may be integrally configured. In this case, the input device 2 and the output device 3 may be formed as a tablet type terminal integral with the information processing device 1. In another example, the information processing device 1 may be formed by a plurality of devices. In this case, the plurality of devices forming the information processing device 1 conduct sending and receiving of information necessary for executing respective pre-allocated processes among the plurality of devices.

(2) Hardware Configuration of Information Processing Device

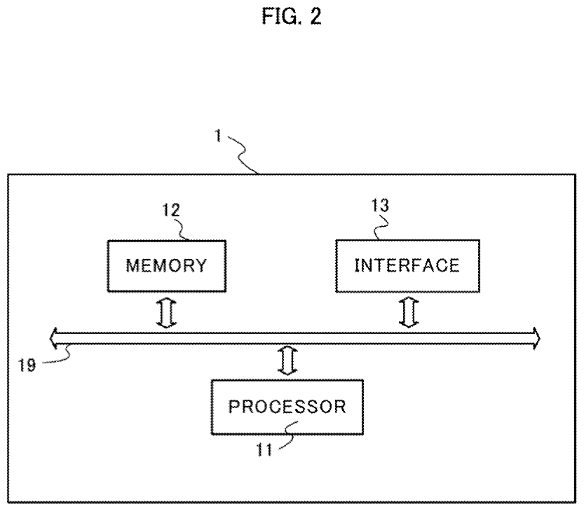

FIG. 2 illustrates a hardware configuration of the information processing device 1. The information processing device 1 includes a processor 11, a memory 12, and an interface 13, as hardware. The processor 11, the memory 12, and the interface 13 are connected via a data bus 19.

The processor 11 executes a predetermined process by executing a program stored in the memory 12. The processor 11 corresponds to one or more processors including at least one of a CPU (Central Processing Unit), a GPU (Graphics Processing Unit), a quantum processor, and the like.

The memory 12 is formed by various volatile and non-volatile memories such as a RAM (Random Access Memory), a ROM (Read Only Memory), and the like. In addition, programs executed by the information processing device 1 are stored in the memory 12. The memory 12 is used as a working memory and temporarily stores information acquired from the storage device 4. Note that the memory 12 may function as the storage device 4. Similarly, the storage device 4 may function as the memory 12 of the information processing device 1. The program executed by the information processing device 1 may be stored in a storage medium other than the memory 12.

The interface 13 is an interface for electrically connecting the information processing device 1 and other devices. For instance, the interface for connecting the information processing device 1 and the other devices may be a communication interface such as a network adapter for performing transmission and reception of data to and from the other devices by wired or wireless based on the control of the processor 11. In another example, the information processing device 1 and the other devices may be connected by a cable or the like. In this case, the interface 13 includes a hardware interface compliant with a USB (Universal Serial Bus), a SATA (Serial AT Attachment), and the like for exchanging data with the other devices.

The hardware configuration of the information processing device 1 is not limited to the configuration depicted in FIG. 2. For instance, the information processing device 1 may include at least one of the input device 2 and the output device 3.

(3) Functional Blocks

The information processing device 1 receives inputs of a user designating parameters (also referred to as “parameters Pd”) concerning inference results Re of the plurality of inference engines, and generates the digest candidate Cd based on the parameters Pd. Here, the parameters Pd are parameters necessary to generate the digest candidate Cd based on the inference results Re of the plurality of inference engines. In the following, the functional blocks of the information processing device 1 for realizing the above-described processes will be described.

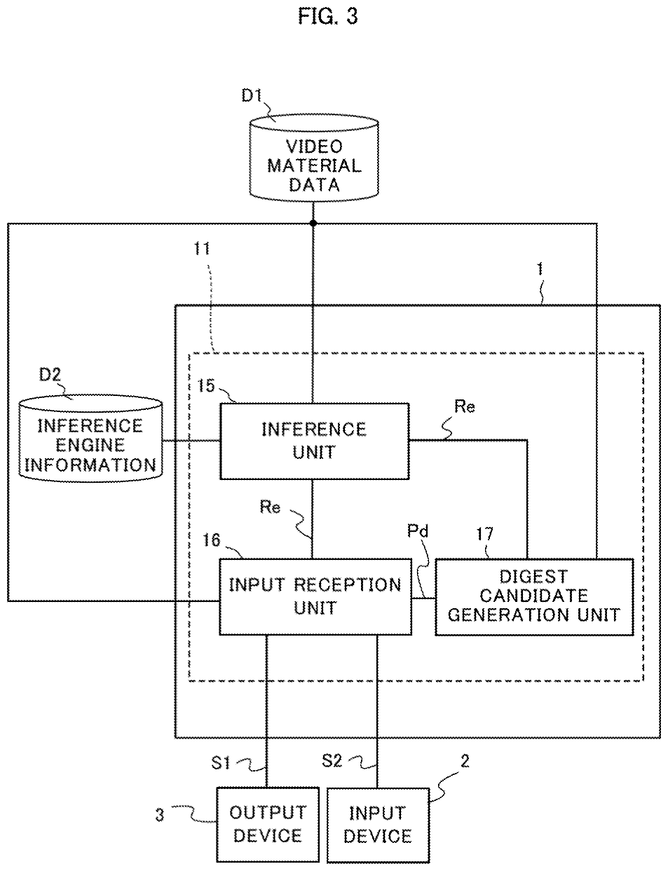

The processor 11 of the information processing device 1 functionally includes an inference engine 15, an input reception unit 16, and a digest candidate generation unit 17. Incidentally, in FIG. 3, blocks to exchange data are connected to each other by a solid line, each combination of the blocks to exchange data is not limited to that as depicted in FIG. 3. The same explanations are applied to a diagram of other functional blocks which will be described later.

The inference unit 15 generates the inference result “Re” for each inference engine by the inference engines formed based on the inference engine information D2 with respect to the video material data D1. Here, the inference result Re represents time series data of a score (also referred to as an “individual score Si”) inferred for each inference engine with respect to the video material data D1. In this case, by sequentially inputting sets of segmented video data, which are the video data obtained by dividing the video material data D1 for each segment, to each of the plurality of inference engines formed by referring to the inference engine information D2, the inference unit 15 calculates the individual score Si in time series for each inference engine for the input segmented video data. Here, the individual score Si becomes higher as the segmented video data are determined to be highly important from a viewpoint targeted by a target inference engine. Next, the inference unit 15 supplies the generated inference result Re to the input reception unit 16 and the digest candidate generation unit 17.

The input reception unit 16 receives inputs of the user designating the parameters Pd which are necessary to select the digest candidate Cd based on the video material data D1 and the inference results Re of the plurality of inference engines. Specifically, the input reception unit 16 sends an output signal 51 for displaying a screen (also referred to as a “digest generation support screen”) for supporting a generation of the digest candidate Cd, to the output device 3 via the interface 13. The digest generation support screen is an input screen for the user to designate the parameters Pd, and a specific example will be described later. Next, the input reception unit 16 receives an input signal S2 concerning the parameters Pd designated in the digest generation support screen from the input device 2 via the interface 13. Subsequently, the input reception unit 16 supplies the parameters Pd specified based on the input signal S2 to the digest candidate generation unit 17.

The parameters Pd correspond to, for instance, information concerning weights (also referred to as “weights W”) that are respectively set for the inference engines to calculate a score (also referred to as a “total score St”) acquired by integrating individual scores Si respective to the inference engines. In another instance, the parameters Pd correspond to information concerning a threshold (also referred to as an “importance determination threshold Th”) for determining an important segment (that is, a segment to be the digest candidate Cd) of the video material data D1 based on the total score St. Initial values of setting values for the parameters Pd are stored in advance in the memory 12 or the storage device 4. The input reception unit 16 updates the setting values of the parameters Pd based on the input signal S2, and stores the setting values of latest parameters Pd in the memory 12 or the storage device 4.

The digest candidate generation unit 17 generates the digest candidate Cd based on the inference results Re respective to the inference engines and the parameters Pd. For instance, the digest candidate generation unit 17 extracts the video data for each segment of the video material data D1 in which the total score St is equal to or higher than the importance determination threshold Th, and generates the video data in which sets of the extracted video data are arranged and combined in time series, as the digest candidate Cd.

Instead of generating one set of video data as the digest candidate Cd, the digest candidate generation unit 17 may generate a list of sets of video data determined to be applicable to the important segments as the digest candidate Cd. In this case, the digest candidate generation unit 17 may cause the output device 3 to display the digest candidate Cd, and receive inputs or the like of the user who selects the video data to be included in a final digest by the input device 2.

The information processing device 1 may regard the digest candidate Cd generated by the digest candidate generation unit 17 as the final digest, and may generate the final digest by further performing an additional process for the digest candidate Cd. In the latter case, for instance, the information processing device 1 may perform the additional process so that a scene including a non-important segment with high relevance to the video data determined to be the important segment is included in the final digest.

Each component of the inference unit 15, the input reception unit 16, and the digest candidate generation unit 17 described with reference to FIG. 3 can be realized, for instance, by the processor 11 executing programs stored in the storage device 4 or the memory 12. In addition, necessary programs may be recorded in any non-volatile storage medium and installed as necessary to realize respective components. These components are not limited to being implemented by software by respective programs, and may be implemented by any combination of hardware, firmware, and software. Each of these components may also be implemented using a user programmable integrated circuit such as an FPGA (field-programmable gate array) or a microcomputer. In this case, the integrated circuit may be used to realize programs formed by the above-described components. Thus, each of the components may be implemented by any controller including hardware other than a processor.

The above explanations are applied to other example embodiments which will be described later.

(4) Digest Generation Support Screen

Next, a specific process executed by the input reception unit 16 will be described together with display examples (a first display example and a second display example) of the digest generation support screen.

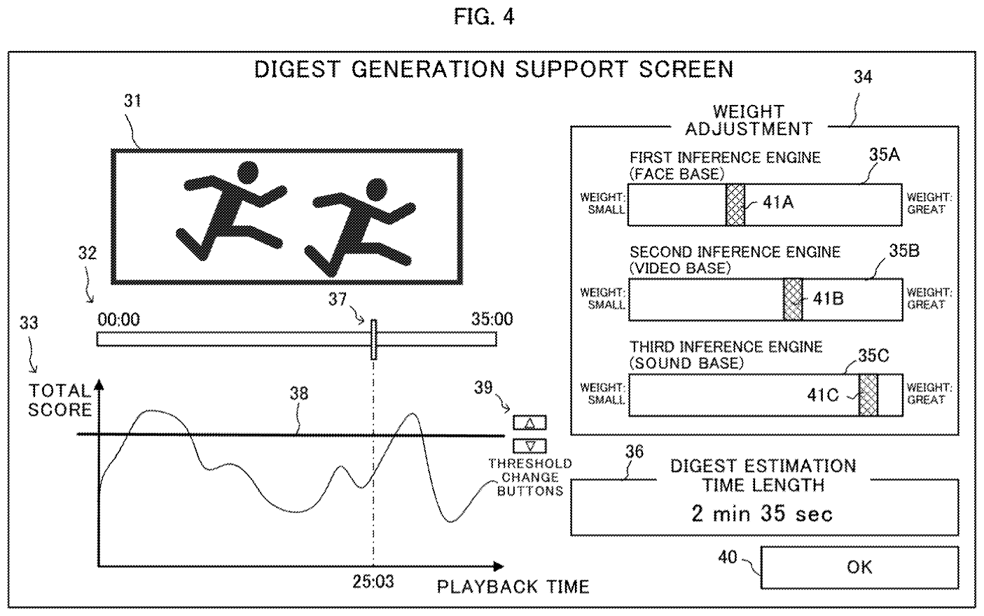

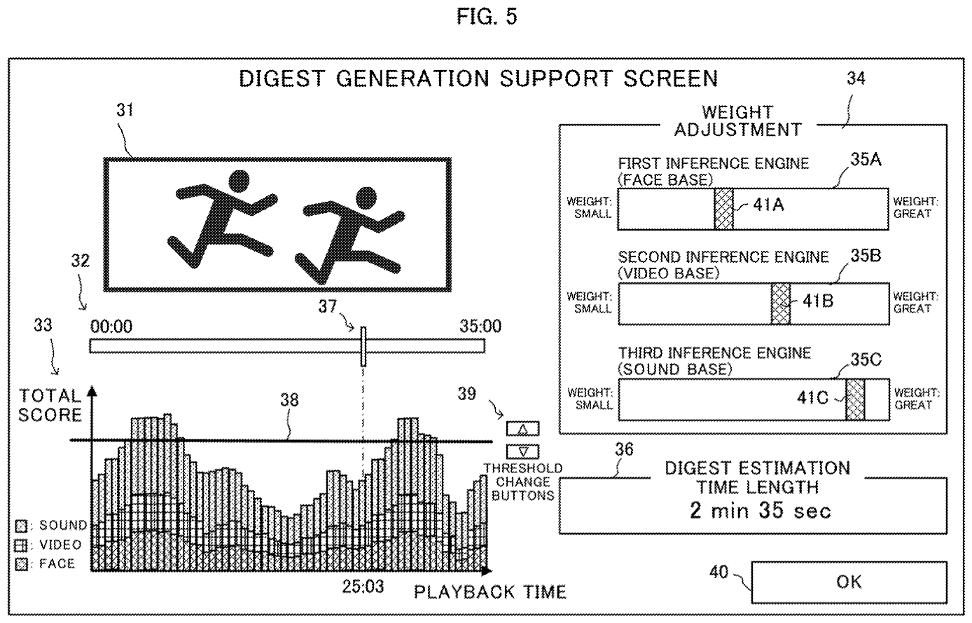

FIG. 4 is the first display example of the digest generation support screen. The input reception unit 16 displays, on the output device 3, the digest generation support screen which allows specifying changes the weights W and the importance determination threshold Th. In this case, the input reception unit 16 supplies the output signal S1 to the output device 3, and displays the above-described digest generation support screen on the output device 3.

The input reception unit 16 includes an image display area 31, a seek bar 32, a total score display area 33, a weight adjustment area 34, an estimated time length display area 36, and an OK button 40 on the digest generation support screen.

The input reception unit 16 displays, in the image display area 31, an image of the video material data D1 corresponding to a playback time designated on the seek bar 32. Here, the seek bar 32 is a bar that specifies a playback time length of the video material data D1 (here, 35 minutes), and a slide 37 is provided to specify an image (here, an image corresponding to 25 minutes and 3 seconds) to be displayed in the image display area 31. The input reception unit 16 determines an image to be displayed in the image display area 31, based on the input signal S2 generated by the input device 2 depending on a position of the slide 37.

Moreover, the input reception unit 16 displays, on the total score display area 33, a line graph which indicates the total score St in time series with respect to the video material data D1. In this case, the input reception unit 16 calculates the total score St in time series for all segments of the video material data D1 based on the inference results Re respective to the inference engines and the weights W, and displays the line graph representing the total score St in time series on the total score display area 33. In addition, the input reception unit 16 displays a threshold line 38 indicating a current setting value of the importance determination threshold Th together with the line graph described above on the total score display area 33.

Furthermore, the input reception unit 16 provides, in the total score display area 33, threshold change buttons 39 which are user interfaces for the user to input a change of the setting value for the importance determination threshold Th. Here, as an example, the input reception unit 16 displays the threshold change buttons 39 formed by two buttons for increasing or decreasing the setting value of the importance determination threshold Th for each predetermined value. Next, upon detecting an input to the threshold change buttons 39 based on the input signal S2, the input reception unit 16 changes the setting value of the importance determination threshold Th, and causes the threshold line 38 to move in accordance with the setting value of the changed importance determination threshold Th. Note that at a time of starting a display of the digest generation support screen, the input reception unit 16 displays the threshold line 38 based on the initial value of the importance determination threshold Th stored in advance in the storage device 4 or the memory 12.

The input reception unit 16 displays, on the weight adjustment area 34, a user interface for adjusting the weight W with respect to each inference engine used to generate the digest candidate Cd. Here, as an example, it is assumed that the inference engine information D2 includes parameters necessary to form each of a first inference engine, a second inference engine, and a third inference engine. Here, the first inference engine infers the degree of importance based on a region of a human face in images forming the video material data D1. The second inference engine infers the degree of importance based on all images forming the video material data D1. The third inference engine infers the degree of importance based on sound data included in the video material data D1.

Next, the weight adjustment area 34 is provided with weight adjustment bars 35A to 35C for adjusting the weights W respectively corresponding to the first inference engine to the third inference engine. Here, the weight adjustment bar 35A is a user interface for adjusting a weight “W1” with respect to an individual score “Si1” output from the first inference engine. Also, the weight adjustment bar 35B is a user interface for adjusting a weight “W2” for an individual score “Si2” output from the second inference engine, and the weight adjustment bar 35C is a user interface for adjusting a weight “W3” for an individual score “Si3” output from the third inference engine. The weight adjustment bars 35A to 35C are respectively provided with slides 41A to 41C, so that the weights W1 to W3 can be adjusted by adjusting individual positions of the slides 41A to 41C. Note that initial values of the weights W are stored in advance in the storage device 4 or the memory 12, and the input reception unit 16 performs each display by referring to the initial values in the weight adjustment area 34 when a display of the digest generation support screen is started.

After that, the input reception unit 16 changes the setting value of a corresponding weight W in response to detecting a movement of one of the slides 41A to 41C based on the input signal S2. Moreover, since the total score St also changes due to a change of the setting value of the weight W, the input reception unit 16 re-calculates the total score St based on the changed setting value of the weight W, and updates the display of the total score display area 33 based on the re-calculated total score St. In this case, for instance, the input reception unit 16 calculates the total score St based on the following equation.

St=(W1·Si1+W2·Si2+W3·Si3)/(W1+W2+W3)

Moreover, the input reception unit 16 updates the display of the estimated time length display area 36 by further re-calculating for a time length of the digest candidate Cd to be displayed in the estimated time length display area 36 which will be described later.

The input reception unit 16 displays, on the estimated time length display area 36, an estimated time length (also referred to as a “digest estimation time length”) of the digest candidate Cd when the digest candidate Cd is generated by current setting values of the parameters Pd (here, the importance determination threshold Th and the weights W).

Next, upon detecting that the OK button 40 is selected, the input reception unit 16 supplies the parameters Pd indicating the current setting value of the current importance determination threshold Th and the current setting values of the weights W to the digest candidate generation unit 17. Upon receiving the parameters Pd, the digest candidate generation unit 17 generates the digest candidate Cd according to the current setting value of the importance determination threshold Th and the current setting values of the weights W which are indicated by the supplied parameters Pd.

After that, the digest candidate generation unit 17 may store the generated digest candidate Cd in the storage device 4 or the memory 12, and may send the generated digest candidate Cd to an external device other than the storage device 4. Moreover, the digest candidate generation unit 17 may send the output signal S1 to the output device 3 so as to play back the digest candidate Cd by the output device 3.

According to the first display example, the information processing device 1 can receive changes of the setting value of the importance determination threshold Th and the setting values of the weights W, and can preferably adjust a time length of the scene to be extracted as the digest and the digest based on the user input. Furthermore, the information processing device 1 can present, to the user, the digest estimation time length which is a guideline for changing the setting value of the importance determination threshold Th and the setting values of the weights W, and can preferably support the above-described adjustment.

FIG. 5 is a second display example of the digest generation support screen. In the second display example, the input reception unit 16 displays, on the total score display area 33, a bar graph (column chart) which specifies a degree of contribution for each of the reference results corresponding to the inference engines in the calculation of the total score St.

Specifically, in the second display example, in a case of displaying the bar graph of the total score St for each predetermined segment on the total score display area 33, the input reception unit 16 specifies contributions respective to the first inference engine to the third inference engine, and displays the specified contributions respective to the first inference engine to the third inference engine in the bar graph with different colors. In this case, the input reception unit 16 regards “(W1·Si1)/(W1+W2+W3)” corresponding to a first term of the calculation equation of the total score St described above, as a contribution of the inference result of the first inference engine. In the same manner, the input reception unit 16 regards “(W2 Si2)/(W1+W2+W3)” as a contribution of the inference result of the second inference engine, and regards “(W3 Si3)/(W1+W2+W3)” as a contribution of the inference engine result of the third inference engine. Moreover, the input reception unit 16 displays the bar graph described above in which blocks having lengths corresponding to respective contributions calculated for each segment are stacked with respective different colors corresponding to the inference engines.

According to the second display example, the input reception unit 16 can preferably present, to the user, the degree of contribution of the inference result for each inference engine. Therefore, it is possible for the user who edits the digest candidate Cd to appropriately comprehend information as a reference in a case of setting the weight W for each inference engine.

(5) Process Flow

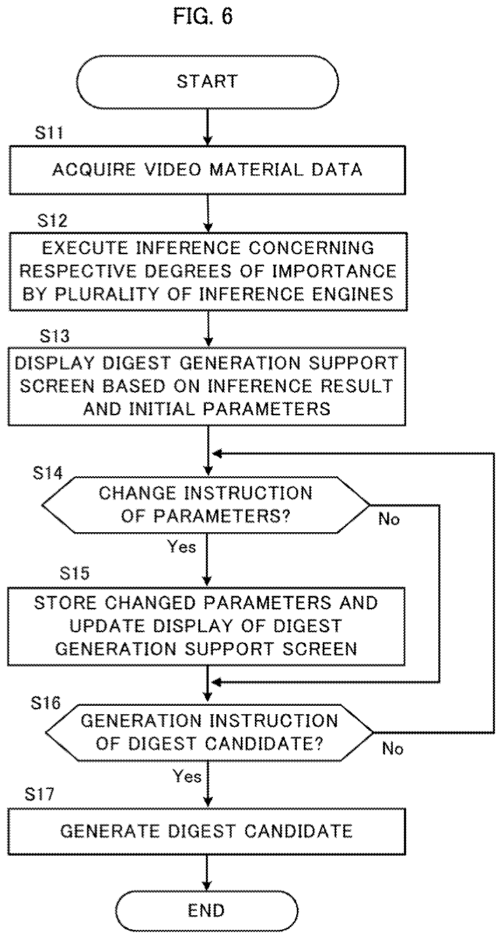

FIG. 6 illustrates an example of a flowchart for explaining steps of a process executed by the information processing device 1 in the first example embodiment. The information processing device 1 executes the process of the flowchart depicted in FIG. 6, for instance, upon detecting an input of the user who instructs a start of the process by specifying the target video material data D1.

First, the information processing device 1 acquires the video material data D1 (step S11). Next, the inference unit 15 of the information processing device 1 executes an inference regarding each degree of importance by a plurality of inference engine units (step S12). In this case, the inference unit 15 calculates individual scores Si in time series for the inference engines with respect to the video material data D1 by using the plurality of inference engines which are formed by referring to the inference engine information D2. The inference unit 15 supplies the inference results Re which indicate the individual scores Si in time series for each inference engine, to the input reception unit 16.

Next, the input reception unit 16 displays the digest generation support screen on the output device 3 based on the inference results Re by the inference unit 15 and the initial values of the parameters Pd (initial parameters) stored in the storage device 4 or the memory 12 or the like (step S13). In this case, the input reception unit 16 generates the output signal 51 for displaying the digest generation support screen, and causes the output device 3 to display the digest generation support screen by sending the output signal 51 to the output device 3 via the interface 13. Accordingly, the input reception unit 16 displays, on the output device 3, the digest generation support screen which specifies the current setting values such as the importance determination threshold Th and the weight W for each of the inference engines.

Next, the input reception unit 16 determines whether or not a change instruction of the parameters Pd is made, based on the input signal S2 supplied from the input device 2 (step S14). In examples in FIG. 4 and FIG. 5, the input reception unit 16 determines whether or not an operation is detected with respect to at least one of the weight adjustment bars 35A to 35C and the threshold change buttons 39.

When the change instruction of the parameters Pd is made (step S14; Yes), the input reception unit 16 stores the changed parameters Pd in the memory 12 or the like, and updates the display of the digest generation support screen based on the changed parameters Pd (step S15). Accordingly, the input reception unit 16 presents, to the user, information concerning the latest digest candidate Cd reflecting the parameters Pd specified by the user, and visualizes the information necessary to determine whether a further change of the parameters Pd is necessary. On the other hand, when no change instruction of the parameters Pd is made (step S14; No), the the input reception unit 16 advances to step S16.

Next, the input reception unit 16 determines whether a generation instruction of the digest candidate Cd is made, based on the input signal S2 supplied from the input device 2 (step S16). In the examples in FIG. 4 and FIG. 5, the input reception unit 16 determines whether the OK button 40 is selected. When the generation instruction of the digest candidate Cd is made (step S16; Yes), the input reception unit 16 generates the digest candidate Cd (step S17). On the other hand, when no generation instruction of the digest candidate Cd is made (step S16; No), the input reception unit 16 goes back to step S14 and determines again whether the change instruction of the parameters Pd is made.

Here, advantages according to the present example embodiment will be supplementary described.

Needs for an automatic editing of a sports video have been increased due to two demands: a time reduction of a video editing and a content expansion concerning the editing of the sports video. In the automatic editing, in order to detect an important scene, there is a case of using a plurality of inference engines: an inference engine which infers the important scene from all images, an inference engine which infers the important scene based on a specific portion in an image, an inference engine which infers the important scene based on sounds, and the like. In this case, in a case of combining all results of the inference engines, a digest with a time length desired by the user may not be obtained. For instance, a two minute digest may be desired, but an eight minute digest may be generated, or a desired highlight scene may not be included in the digest even if the time length of the digest is forcibly fixed. Therefore, it is desirable that the user who is an editor can adjust the parameters for selecting the digest candidate Cd by combining results respective to the inference engines.

In view of the above, in the first example embodiment, the information processing device 1 accepts an input for instructing a change of the parameters Pd on the digest generation support screen and allows the user who is the editor to adjust the parameters Pd. Therefore, it is possible for the information processing device 1 to preferably support the generation of a digest time desired by the user.

(6) Modifications

Next, each of modifications preferable for the above example embodiment will be described. The following modifications may be applied to the example embodiments described above in any combination.

(Modification 1) The information processing device 1 may specify, on the digest generation support screen, the parameters Pd recommended to achieve the time length of the digest desired by the user on the digest generation support screen.

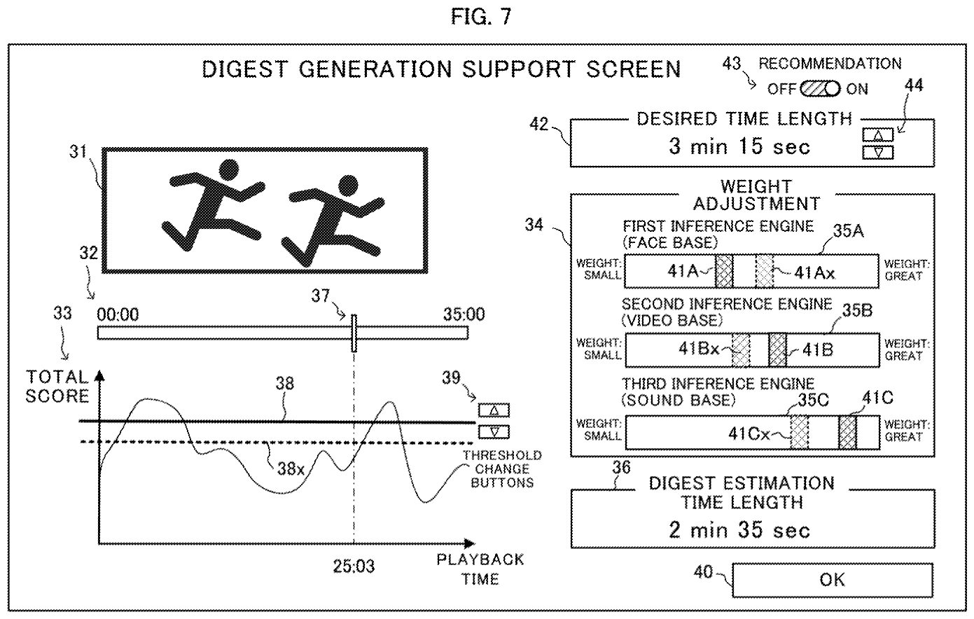

FIG. 7 illustrates a third display example of the digest generation support screen. The input reception unit 16 provides a desired time length display field 42 and a recommendation switch button 43 on the digest generation support screen according to the third display example.

The desired time length display field 42 is a field for displaying the playback time length (also referred to as a “desired time length”) of the digest candidate Cd desired by the user. Incidentally, the desired time length display field 42 is provided with increase and decrease buttons 44, and the input reception unit 16 changes the desired time length to be displayed in the desired time length field 42 by detecting an operation with respect to the increase and decrease buttons 44. The recommendation switch button 43 is a button for switching ON and OFF of a recommendation display concerning the importance determination threshold Th and the weight W in the total score display area 33 and the weight adjustment area 34. In the third display example, the recommended display is set to ON.

The input reception unit 16 calculates recommended values for the importance determination threshold Th and the weight W based on the desired time length specified in the desired time length display field 42. Next, the input reception unit 16 displays a recommended threshold line 38x indicating the recommended value calculated for the importance determination threshold Th on the total score display area 33, and displays virtual slides 41Ax to 41Cx indicating respective recommended values for the weights W1 to W3 on the weight adjustment bars 35A to 35C. In this case, for instance, the input reception unit 16 calculates the recommended values of the importance determination threshold Th and the weights W by performing an optimization which maximizes an evaluation function that indicates a higher evaluation as a difference between the current set values of the importance determination threshold Th and the weights W and the recommended values decreases, under a constraint condition in which the digest estimation time length is the desired time length. In another example embodiment, the input reception unit 16 may determine the recommended values of the importance determination threshold Th and the weights W based on performance information concerning past digest generations stored in the storage device 4 or the like.

Note that instead of displaying the recommended values for both the importance determination threshold Th and the weight W, the input reception unit 16 may display either a recommended value of the importance determination threshold Th or recommended values of the weights W. In this case, the input reception unit 16 may further display, on the digest generation support screen, a user interface which receives an input for selecting whether to display the recommended value of the importance determination threshold Th or the recommended values of the weights W. In this case, the input reception unit 16 fixes a parameter for which the recommended value is not calculated, to be the current setting value, and calculates the recommended values of the parameters for displaying the recommended value, by the above-described optimization or the like.

According to this modification, it is possible for the information processing device 1 to preferably present, to the user who is the editor, the recommended values of the parameters Pd as the guideline for realizing the desired time length. By preferably presenting the recommended values, it is possible for the user who is the editor to comprehend the guideline of which parameter needs to be changed and by how much.

(Modification 2)

The digest generation support system 100 may be a server client model.

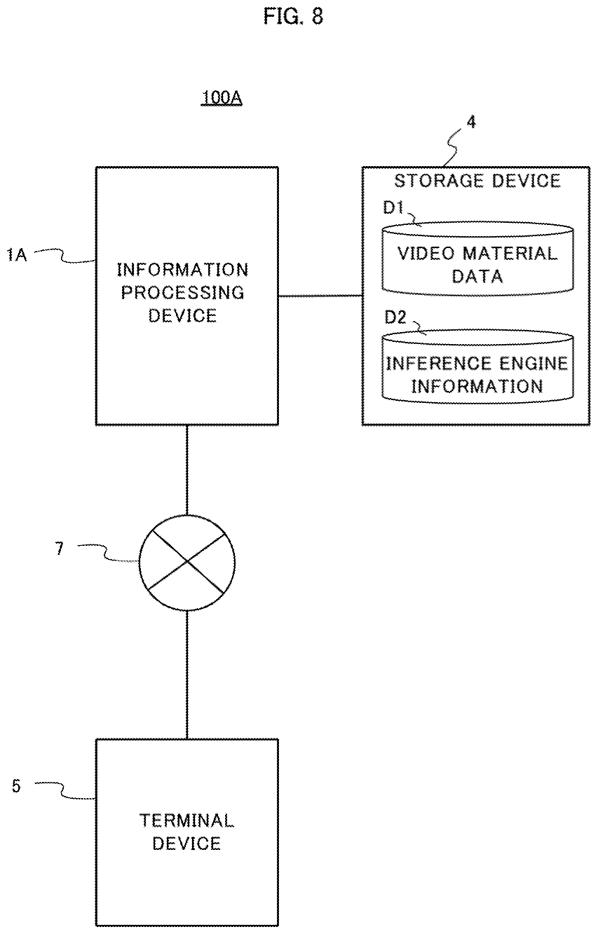

FIG. 8 illustrates a configuration of a digest generation support system 100A in Modification 2. As depicted in FIG. 8, the digest generation support system 100A mainly includes an information processing device 1B which functions as a server, a storage device 4 which stores information necessary to generate the digest candidate Cd, and a terminal device 5 which functions as a client. The information processing device 1A and the terminal apparatus 5 perform data communications via a network 7.

The terminal device 5 is a terminal having at least an input function, a display function, and a communication function, and functions as the input device 2 and the output device 3 (that is, a display device) depicted in FIG. 1. The terminal device 5 may be, for instance, a personal computer, a tablet-type terminal, a PDA (Personal Digital Assistant), or the like.

The information processing device 1A includes the same configuration as that of the information processing device 1 depicted in FIG. 1, and executes a process of the flowchart depicted in FIG. 6. Here, in step S13 and step S15, a display signal for displaying the digest generation support screen is sent to the terminal device 5 via the network 7. Moreover, in step S14 and step S16, the information processing device 1A receives an input signal indicating an instruction of the user from the terminal device 5 via the network 7. In this modification, the information processing device 1A can receive an input of a change of the parameters Pd to the user who operates the terminal device 5 and can preferably generate the digest candidate Cd.

### Second Example Embodiment

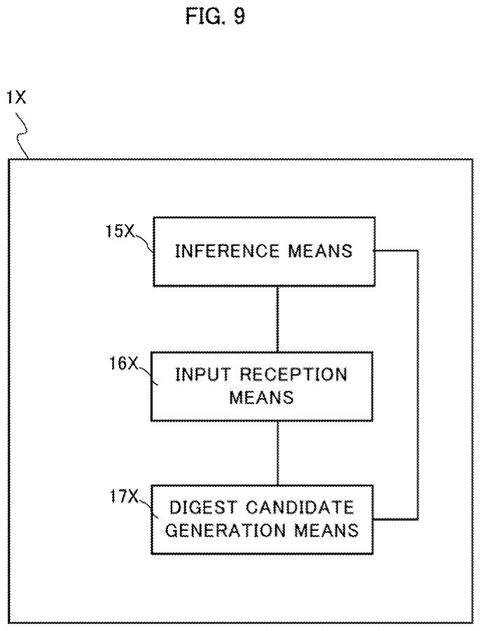

FIG. 9 is a functional block diagram of an information processing device 1X according to a second example embodiment. The information processing device 1X mainly includes an inference means 15X, an input reception means 16X, and a digest candidate generation means 17X.

The inference means 15X acquires the inference result for each inference engine to the video material data by a plurality of inference engines which perform inference concerning the degree of importance with respect to video data being input. Here, in a first example, the inference means 15X generates the inference result for each inference engine using the plurality of inference engines. In this instance, the inference means 15X may be the inference unit 15 of the first example embodiment (including modifications, the same applies hereinafter). In a second example, the inference means 15X receives the inference result from an external device which generates the inference result for each inference engine by using the plurality of inference engines. In this case, for instance, the inference means 15X receives the inference result Re from an external device which includes a function corresponding to the inference unit 15 of the first example embodiment.

The input reception means 16X receives an input which specifies parameters concerning the inferenced result for each inference engine. Here, the input reception means 16X may be the input reception unit 16 of the first example embodiment. The “parameters concerning the inference result for each inference engine” may be at least one of the importance determination threshold Th and the weight W of the first example embodiment.

The digest candidate generation means 17X generates the digest candidate which is a candidate for the digest of the video material data, based on the parameters and respective inference results of the inference engines. Here, the digest candidate generation means 17X may be the digest candidate generation unit 17 of the first example embodiment.

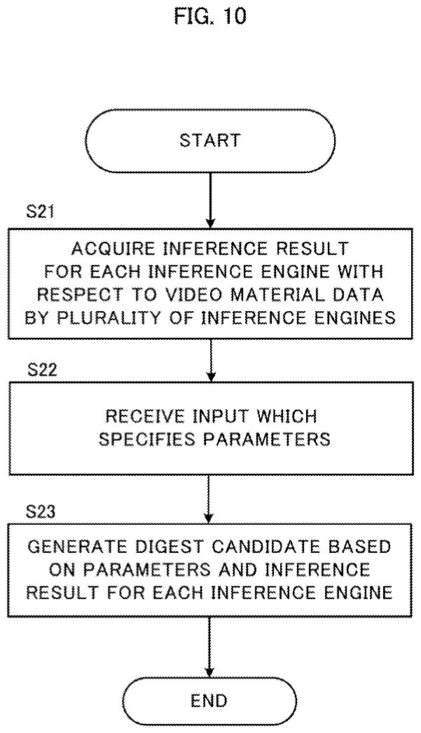

FIG. 10 is an example of a flowchart for a process executed by the information processing device 1X in the second example embodiment. First, the inference means 15X acquires the inference result for each inference engine with respect to the video material data by the plurality of inference engines which perform an inference concerning the degree of importance for video data being input (step S21). The input reception means 16X receives an input which specifies parameters concerning the inference result for each inference engine (step S22). The digest candidate generation means 17X generates the digest candidate based on the parameters and the inference result for each inference engine (step S23).

The information processing device 1X according to the second example embodiment can integrate the inference results of the plurality of inference engines based on the parameters specified by the user, and can preferably generate the digest candidate.

In the example embodiments described above, programs may be stored using various types of non-transitory computer readable media (non-transitory computer readable media), and can be supplied to a computer such as a processor. The non-transitory computer-readable media include various types of tangible storage media (tangible storage media). Examples of non-transitory computer readable media include a magnetic storage medium (that is, a flexible disk, a magnetic tape, a hard disk drive), a magnetic optical storage medium (that is, a magnetic optical disk), a CD-ROM (Read Only Memory), a CD-R, a CD-R/W, a semiconductor memory (that is, a mask ROM, a PROM (Programmable ROM), an EPROM (Erasable PROM), a flash ROM, a RAM (Random Access Memory), and the like. Each program may also be provided to the computer by various types of transitory computer readable media (transitory computer readable media). In the examples of the transitory computer readable media, recording means include electrical signals, optical signals, and electromagnetic waves. Each transitory computer readable medium can provide the programs to the computer through wired channels such as electrical wires and optical fibers, or wireless channels.

A part or all of the example embodiments described above may also be described as the following supplementary notes, but not limited thereto.

(Supplementary Note 1)

1. An information processing device comprising:

an inference means configured to acquire an inference result for each inference engine to video material data by a plurality of inference engines which perform respective inferences concerning a degree of importance with respect to video data being input;

an input reception means configured to receive an input indicating parameters concerning the inference result for each inference engine; and

a digest candidate generation means configured to generate a digest candidate which is a candidate of a digest of the video material data, based on the parameters and the inference result for each inference engine.

(Supplementary Note 2)

2. The information processing device according to supplementary note 1, wherein

the parameters include at least information concerning a weight to the inference result for each inference engine, and

the digest candidate generation means extracts the digest candidate from the video material data based on the weight and the inference result for each inference engine.

(Supplementary Note 3)

3. The information processing device according to supplementary note 1 or 2, wherein

the parameters include at least information concerning a threshold with respect to a total score integrating respective inference results of the inference engines, and

the digest candidate generation means extracts the digest candidate from the video material data based on the threshold and the total score.

(Supplementary Note 4)

4. The information processing device according to supplementary note 3, wherein the input reception means performs a display of a graph of the total score in which a current setting value of the threshold is specified.

(Supplementary Note 5)

5. The information processing device according to supplementary note 3 or 4, wherein the input reception means performs a display of a graph of the total score in which a contribution of the inference result for each inference engine is specified with respect to the total score.

(Supplementary Note 6)

6. The information processing device according to any one of supplementary notes 1 to 5, wherein the input reception means performs a display of information concerning time length of the digest candidate in a case where the digest candidate is generated based on current settings of the parameters.

(Supplementary Note 7)

7. The information processing device according to any one of supplementary notes 1 to 6, wherein the input reception means receives at least an input indicating a desired time length of the digest candidate, and performs a display of recommended setting values of the parameters in order to make a time length of the digest candidate be the desired time length.

(Supplementary Note 8)

8. The information processing device according to any one of supplementary notes 4 to 7, wherein the input reception means causes a display device to execute the display, by sending a display signal to the display device.

(Supplementary Note 9)

9. The information processing device according to any one of supplementary notes 1 to 8, wherein the inference means acquires at least inference results of an inference engine which performs an inference concerning a degree of importance based on images included in the video material data and an inference engine which performs an inference concerning the degree of importance based on sound data included in the video material data.

(Supplementary Note 10)

10. The information processing device according to any one of supplementary notes 1 to 9, wherein the inference means acquires at least inference results of an inference engine which performs an inference concerning the degree of importance based on an entire area of each of images included in the video material data and of an inference engine which performs an inference concerning the degree of importance based on an area indicating a specific portion in the images included in the video material data.

(Supplementary Note 11)

11. A control method performed by a computer, the control method comprising:

acquiring an inference result for each inference engine to video material data by a plurality of inference engines which perform respective inferences concerning a degree of importance with respect to video data being input;

receiving an input indicating parameters concerning the inference result for each inference engine; and

generating a digest candidate which is a candidate of a digest of the video material data, based on the parameters and the inference result for each inference engine.

(Supplementary Note 12)

12. A recording medium storing a program, the program causing a computer to perform a process comprising:

acquiring an inference result for each inference engine to video material data by a plurality of inference engines which perform respective inferences concerning a degree of importance with respect to video data being input;

receiving an input indicating parameters concerning the inference result for each inference engine; and

generating a digest candidate which is a candidate of a digest of the video material data, based on the parameters and the inference result for each inference engine.

Although the present invention has been described with reference to the embodiments, the present invention is not limited to the above embodiments.

Various changes that can be understood by those skilled in the art can be made to the configuration and details of the present invention within the scope of the present invention. That is, the present invention naturally includes various variations and modifications that a person skilled in the art can make according to the entire disclosure including the scope of claims and technical ideas. In addition, the disclosures of the cited patent documents and the like are incorporated herein by reference.

### DESCRIPTION OF SYMBOLS

1, 1A, 1X Information processing device

2 Input device

3 Output device

4 Storage device

5 Terminal device

100, 100A Digest generation support system

What is claimed is:

1. An information processing device comprising:
a memory storing instructions; and
one or more processors configured to execute the instructions to:
acquire an inference result for each inference engine to video material data by a plurality of inference engines which perform respective inferences concerning a degree of importance with respect to video data being input;
receive an input indicating parameters concerning the inference result for each inference engine; and
generate a digest candidate which is a candidate of a digest of the video material data, based on the parameters and the inference result for each inference engine.

2. The information processing device according to claim 1, wherein
the parameters include at least information concerning a weight to the inference result for each inference engine, and
the processor extracts the digest candidate from the video material data based on the weight and the inference result for each inference engine.

3. The information processing device according to claim 1, wherein
the parameters include at least information concerning a threshold with respect to a total score integrating respective inference results of the inference engines, and
the processor extracts the digest candidate from the video material data based on the threshold and the total score.

4. The information processing device according to claim 3, wherein the processor performs a display of a graph of the total score in which a current setting value of the threshold is specified.

5. The information processing device according to claim 3, wherein the processor performs a display of a graph of the total score in which a contribution of the inference result for each inference engine is specified with respect to the total score.

6. The information processing device according to claim 1, wherein the processor performs a display of information concerning time length of the digest candidate in a case where the digest candidate is generated based on current settings of the parameters.

7. The information processing device according to claim 1 wherein the processor receives at least an input indicating a desired time length of the digest candidate, and performs a display of recommended setting values of the parameters in order to make a time length of the digest candidate be the desired time length.

8. The information processing device according to claim 4, wherein the processor causes a display device to execute the display, by sending a display signal to the display device.

9. The information processing device according to claim 1, wherein the processor acquires at least inference results of an inference engine which performs an inference concerning a degree of importance based on images included in the video material data and an inference engine which performs an inference concerning the degree of importance based on sound data included in the video material data.

10. The information processing device according to claim 1, wherein the processor acquires at least inference results of an inference engine which performs an inference concerning the degree of importance based on an entire area of each of images included in the video material data and of an inference engine which performs an inference concerning the degree of importance based on an area indicating a specific portion in the images included in the video material data.

11. A control method performed by a computer, the control method comprising:
acquiring an inference result for each inference engine to video material data by a plurality of inference engines which perform respective inferences concerning a degree of importance with respect to video data being input;
receiving an input indicating parameters concerning the inference result for each inference engine; and
generating a digest candidate which is a candidate of a digest of the video material data, based on the parameters and the inference result for each inference engine.

12. A non-transitory computer-readable recording medium storing a program, the program causing a computer to perform a process comprising:
acquiring an inference result for each inference engine to video material data by a plurality of inference engines which perform respective inferences concerning a degree of importance with respect to video data being input;
receiving an input indicating parameters concerning the inference result for each inference engine; and
generating a digest candidate which is a candidate of a digest of the video material data, based on the parameters and the inference result for each inference engine.
